(19) United States
(12) Patent Application Publication
(10) Pub. No.: US 2020/0236210 A1
(43) Pub. Date: Jul. 23, 2020

(54) Message Storage and Retrieval Software Application

(71) Applicant: Heiko Thomas Kempe, Chetwynd (CA)

(72) Inventor: Heiko Thomas Kempe, Chetwynd (CA)

(21) Appl. No.: 16/250,183

(22) Filed: Jan. 17, 2019

(51) Int. Cl. H04M 1/725; H04W 4/20; G06F 16/182; G06F 16/17; G06F 16/16

(52) U.S. Cl. CPC H04M 1/72547; H04M 1/72525; H04W 4/20; G06F 8/61; G06F 16/1734; G06F 16/162; G06F 16/183

(57) ABSTRACT

A data retrieval and storage system configured to provide access to data on a cellular phone during periods of inoperable communication with a cellular data network. The software application of the present invention is configured to provide monitoring of the data connection between the cellular phone and a data network. As a user receives new data files by way of example but not limitation, voice data files, text data files and data from data sources, the present invention will store the data onto the local memory of the cellular phone. The software application determines if a data file has been accessed by a user. If a user has not accessed the data file a copy thereof is maintained on the memory of the cellular phone so as to provide access thereto during time periods wherein the cellular phone is not communicably coupled to a data network.

### FIELD OF THE INVENTION

The present invention relates generally to electronic data transfer for telecommunications, more specifically but not by way of limitation, a software application configured to be installed on a phone wherein the software application is operable to capture voice and/or text data and make available to a user of the phone when the phone is not actively connected to a data network.

### BACKGROUND

Most individuals utilize a cellular phone as part of the daily routines. Whether for personal reasons or business, the proliferation of cellular phones has resulted into the daily integration of our lives. As cellular phones have evolved over the last decade they now essentially are small computing devices that have the ability to receive, store, manipulate and transmit data. A multitude of software applications are now available for download onto cellular phones and the software applications are programmed to perform a variety of tasks. While the cellular phone has advanced, one drawback is that the cellular phone must still be operably coupled to the data network for some features to be available and/or utilized.

One issue with cellular phones is their inability to access either text or voice data when the phone is not communicably coupled to the data network. Conventional cellular phone technology requires that a cellular phone must have an active connection to the data network and as such the data servers forming a part thereof in order to retrieve either a text data message or a voice data message. While the cellular networks have been extensively expanded over the last decade, there are still many areas wherein a cellular phone cannot establish an active communication with a cellular tower of a cellular network. During the presence of the aforementioned areas, a user is unable to access voicemail data and/or text data.

Accordingly, there is a need for a software application that is configured to facilitate the transfer of data from a data network server to the local memory of the cellular phone so as to provide a user access thereto when the cellular phone is not communicably coupled to the cellular data network.

### SUMMARY OF THE INVENTION

It is the object of the present invention to provide a software application for a cellular phone that provides access to data when the cellular phone is not communicably coupled to the cellular data network wherein the software application is provided to a user for download onto a cellular phone.

Another object of the present invention is to provide a cellular phone software application operable to facilitate data transfer from a data network server to the memory of the cellular phone wherein the software application is configured to retrieve and store both voice and SMS text data.

A further object of the present invention is to provide a software application for a cellular phone that provides access to data when the cellular phone is not communicably coupled to the cellular data network wherein the software application has the ability to detect when a cellular phone is communicably coupled to a cellular data network.

Still another object of the present invention is to provide a cellular phone software application operable to facilitate data transfer from a data network server to the memory of the cellular phone wherein the software application facilitates the transfer of a voice data file from the data network server during a time period of communicable connection with the data network.

An additional object of the present invention is to provide a software application for a cellular phone that provides access to data when the cellular phone is not communicably coupled to the cellular data network wherein the software application further captures email data files.

Yet a further object of the present invention is to provide a a cellular phone software application operable to facilitate data transfer from a data network server to the memory of the cellular phone wherein the software application is able to cross reference the data files on the data server and the memory of the cellular phone and provide access to new and/or previously transmitted data files.

Another object of the present invention is to provide a software application for a cellular phone that provides access to data when the cellular phone is not communicably coupled to the cellular data network wherein the software application further can be programmed to collect data from alternate sources such as but not limited to message boards, weather sources and financial markets and provide capture thereof for display during time periods inoperable communication with a cellular data network.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a diagrammatic view of the components of the present invention; and

FIG. 2 is an exemplary flowchart of the process facilitated by the system present invention; and

FIG. 3 is an additional exemplary flowchart of a process facilitated by the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a data retrieval and storage software application 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

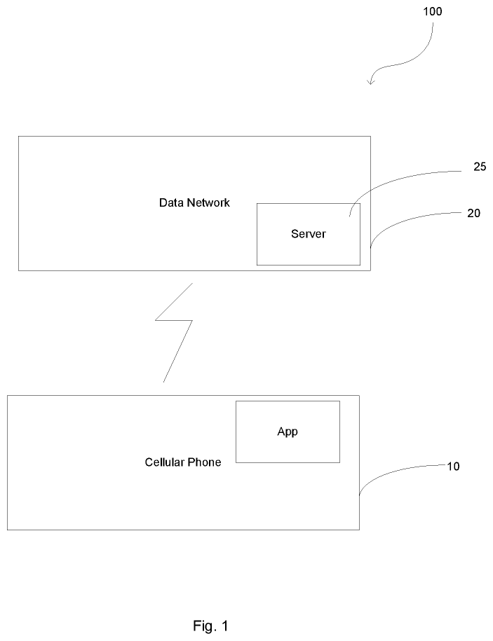

Referring in particular to FIG. 1, the data retrieval and storage software application 100 includes at least one cellular phone 10 having the necessary electronics to store, receive, transmit and manipulate data. It should be understood by those skilled in the art the data retrieval and storage software application 100 would include a multitude of cellular phones and that FIG. 1 is exemplary only. The cellular phone 10 is communicably coupled to at least one data network 20. The data network 20 as is known in the art is a compilation of transmission towers wherein the transmission towers are configured to transmit and receive data. The data network 20 has as a part thereof at least one database server 25. The database server 25 is a conventional computer server wherein the database server 25 includes the electronics to store, receive, transmit and manipulate data. It should be understood within the scope of the present invention that the data network 20 could include a multitude of database servers 25. The database servers 25 function to capture and store data such as but not limited to voice data files and SMS data files for transmission to cellular phones 10 communicably coupled to the data network 20.

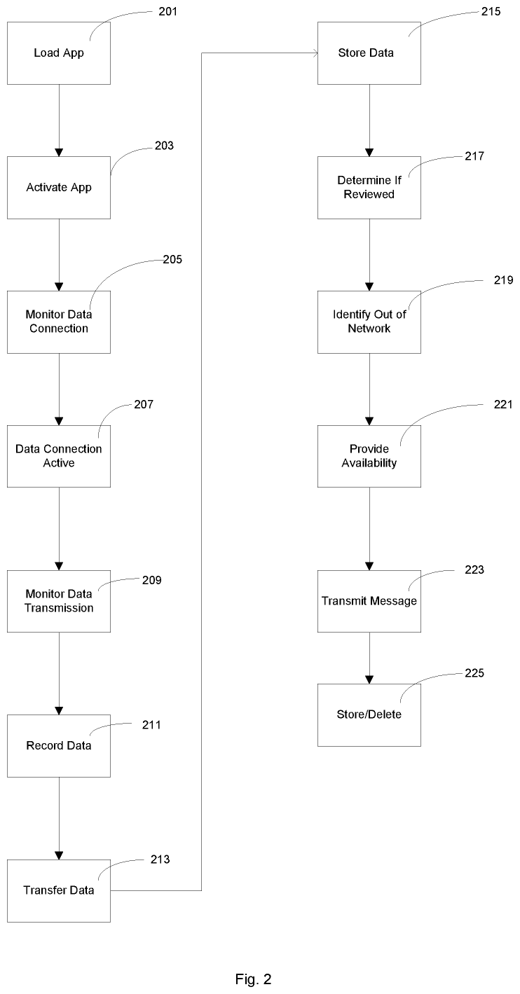

Referring in particular to FIG. 2, the data retrieval and storage software application 100 facilitates a desired process for providing voice data files and other types of data files available to a user of a cellular phone 10 during time periods of communication disconnection with the data network 20. In step 201, a user of a cellular phone 10 will utilize the graphical interface thereof to navigate to a website or similar location wherein the software application of the present invention can be downloaded to the cellular phone 10. Step 203, the software application of the present invention is activated wherein the software application of the present invention operates in a background capacity. In step 205, the software application of the present invention provides continuous monitoring of the communication connection intermediate the cellular phone 10 and the data network 20. In step 207, the software application determines that the data connection with the data network 20 is active. Step 209, the software application provides monitoring of all data file transmissions intermediate the cellular phone 10 and the data network 20. It should be understood within the scope of the present invention that the software application provides monitoring of all data file types such as but not limited to voice data files and text data files. In step 211, the server 25 will provide recording of data files such as but not limited to voice data files. In step 213, the software application identifies new data files on the database server 25 that have not been either displayed or broadcast to the user of the cellular phone 10 and transfer these files to the memory of the cellular phone 10. Step 215, the software application will store the data to the memory of the cellular phone. In step 217, the software application will continue to monitor if the data files are reviewed by the user of the cellular phone 10. If the data files are not reviewed by the cellular phone 10 user, the software application will maintain a copy thereof in the local memory of the cellular phone 10. It should be understood within the scope of the present invention that the user could program the software application to either retain all data files or retain only those data files that have not been reviewed by the user of the cellular phone 10.

In step 219, the software application of the present invention identifies that the cellular phone 10 is no longer communicably connected to the data network 20. Step 221, the software application provides availability to a user any voice data file or text data file that was transmitted during a period of communicable connection to the data network 20 but has not yet been reviewed by the user. In step 223, the user will select a voice data file and/or text data file cataloged in the software application of the present invention and transmit to the user from the local memory of the cellular phone 10. Step 225, ensuing review of the data file, the software application will provide a user an option to return the data file to storage on the local memory of the cellular phone 10 or to delete the data file.

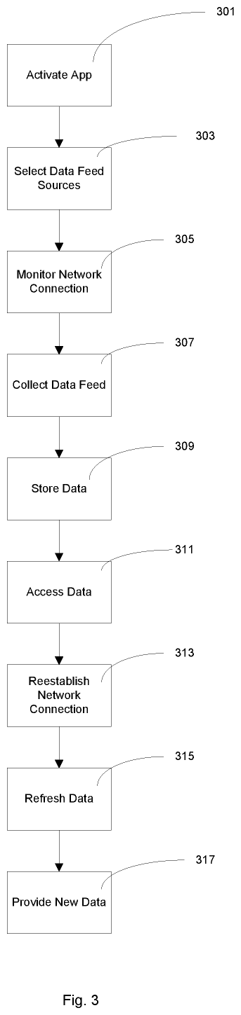

Now referring in particular to FIG. 3, an exemplary process of collection of data from news sources and other types of data feeds is outlined therein. In step 301, a user will active the software application of the present invention. Step 303, the software application will provide the option to select data feeds for the software application to monitor. By way of example but not limitation, a user can select financial market data feeds, social media platforms or weather information. In step 305, the software application will monitor the communicable connection intermediate the cellular phone 10 and the data network 20 to ensure an active connection. In step 307, the selected data feeds are collected and stored in the local memory of the cellular phone 10. It is contemplated within the scope of the present invention that the software application will monitor and store data from the selected data feeds at predetermined intervals such as but not limited to every two minutes. Step 309, the most recent data collected from the data feeds is stored in the local memory of the cellular phone 10. In step 311, the user will access the data stored from the data feeds wherein the user does not have to ensure the cellular phone 10 has an active communicable connection with the data network as the data from the data feeds is stored in the local memory of the cellular phone 10. Step 313, a cellular phone 10 will reestablish an operable communicable connection with the data network 20 subsequent a time period wherein the cellular phone 10 was disconnected therefrom. In step 315, the software application will facilitate the refresh of the data from the selected data feeds. In step 317, the refreshed data is made available to a user and is stored in the local memory of the cellular phone 10 until the data is refreshed as previously discussed herein.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. A data retrieval and storage system configured to provide access to the data during periods of inoperable communication with a cellular data network comprising the steps of:
providing a software application, said software application being available for download onto a computing device;
downloading the software application to a cellular phone;
activating the software application;
monitoring the data connection between the cellular phone and a cellular data network;
monitoring for data files;
reviewing the data files to determine if the data files have been accessed by a user of the cellular phone;
identifying new data files that have not been accessed by the user;
transferring the new data files to the cellular phone;
storing the new data files on the cellular phone;
losing communicable connection with the data network, wherein the cellular phone loses connection with the data network;
providing availability to the new data files, wherein the software application provides availability to the new data files during a time period when the cellular phone does not have an active connection with the cellular data network.

2. The data retrieval and storage system as recited in claim 1, and further including the step of transferring the new data files to local memory of the cellular phone.

3. The data retrieval and storage system as recited in claim 2, and further including the step of determining if a data file has been reviewed.

4. The data retrieval and storage system as recited in claim 3, and further including the step of identifying data feeds to be selected for consistent update of data therefrom.

5. The data retrieval and storage system as recited in claim 4, and further including the step of providing a user an ability to store or delete a data file ensuing the data file being reviewed by the user.

6. The data retrieval and storage system as recited in claim 5, and further including the step of collecting data from the data feeds, wherein the data from the data feeds is collected in distinct intervals and replaces previously collected data.

7. The data retrieval and storage system as recited in claim 6, and further including accessing the data during a time period when the cellular phone is not connected to the data network.

8. A system that provides a user of a cellular phone access to various data files during time periods when the cellular phone is not communicably coupled to a data network comprising the steps of:
providing a software application, said software application being available for download onto a computing device;
downloading the software application to a cellular phone;
activating the software application, wherein the software application operates in a background environment;
monitoring the data connection between the cellular phone and a cellular data network, wherein the software application provides continuous monitoring of a data connection intermediate the cellular phone and the data network;
monitoring for data files, wherein the software application identifies the data files as being part of a first group of data files or a second group of data files, wherein the second group of data files have not been accessed by a user of the cellular phone;
storing the second group of data files on the cellular phone, wherein the software application of the present invention creates a copy of the second group of data files and transfers for storage on the cellular phone;
losing communicable connection with the data network, wherein the cellular phone loses connection with the data network;
providing availability to the second group of data files, wherein the software application provides availability to the second group of data files that have not been reviewed by the user during a time period when the cellular phone does not have an active connection with the cellular data network.

9. The system that provides a user of a cellular phone access to various data files during time periods when the cellular phone is not communicably coupled to a data network as recited in claim 8, and further including the step of identifying data feed sources, wherein data from the data feed sources are monitored by the software application.

10. The system that provides a user of a cellular phone access to various data files during time periods when the cellular phone is not communicably coupled to a data network as recited in claim 9, and further including the step of determining if a data file was accessed by a user and wherein if a data file has not been accessed by a user maintaining a stored copy thereof on the cellular phone.

11. The system that provides a user of a cellular phone access to various data files during time periods when the cellular phone is not communicably coupled to a data network as recited in claim 10, and further including the step of providing a user the option to re-store or delete a data file ensuing access thereof during a time period wherein the cellular phone is not communicably coupled to the data network.

12. The system that provides a user of a cellular phone access to various data files during time periods when the cellular phone is not communicably coupled to a data network as recited in claim 11, and further including the step of and further including the step of collecting data from the data feeds, wherein the data from the data feeds is collected in distinct intervals and replaces previously collected data.

13. The system that provides a user of a cellular phone access to various data files during time periods when the cellular phone is not communicably coupled to a data network as recited in claim 12, and further including the step of accessing a data file during a time period when the cellular phone is not connected to the data network.

14. The system that provides a user of a cellular phone access to various data files during time periods when the cellular phone is not communicably coupled to a data network as recited in claim 13, and further including the step of refreshing data from the selected data feeds during a time period when the cellular phone is communicably coupled to the data network.
